(19) United States
(12) Patent Application Publication
(10) Pub. No.: US 2007/0268318 A1
(43) Pub. Date: Nov. 22, 2007

(54) LIGHT CIRCUIT

(75) Inventors: Xu-Chen Mu, Shenzhen City (CN); Shin-Hong Chung, Shenzhen City (CN); Han-Che Wang, Shenzhen City (CN); Kuan-Hong Hsieh, Shenzhen City (CN)

Correspondence Address: NORTH AMERICA INTELLECTUAL PROPERTY CORPORATION, P.O. BOX 506, MERRIFIELD, VA, 22116, US

(73) Assignees: ENSKY TECHNOLOGY (SHENZHEN) CO., LTD., Shenzhen City (CN); ENSKY TECHNOLOGY CO., LTD., Taipei Hsien (TW)

(21) Appl. No.: 11/750,340

(22) Filed: May 18, 2007

(30) Foreign Application Priority Data
May 19, 2006 (CN) 200610060728.9

(51) Int. Cl. G09G 5/10

(52) U.S. Cl. 345/691

(57) ABSTRACT

A light circuit includes a light unit (7), a control unit (3), a differentiating circuit (4) and a switching circuit (6). The light unit includes a plurality of light branches (L1, L2 . . . and Ln) connected in parallel. The light branches are controlled to light by the switching circuit that is enabled and disabled by PWM waves from the control unit. The PWM waves are differentiated into differentiated waves by the differentiating circuit before outputted to control the switching circuit.

### TECHNICAL FIELD

The present invention relates to light circuits, and more particularly, to a light circuit used for lighting an electronic device.

### RELATED ART

PWM (pulse width modulation) waves are employed to control lighting of electroluminescent bodies, such as light emitting diodes (LEDs). The PWM waves are produced by a PWM generating circuit that is usually configured in a PWM integrated circuit (IC) chip. Generally, the PWM generating circuit outputs the PWM waves at a suitable duty cycle, thus controlling the electroluminescent bodies to a suitable luminance level as required. However, when the PWM IC chip works abnormally and outputs 100% duty cycle PWM waves uninterruptedly, the electroluminescent bodies will be at a highest luminance level continuously. If this excessive luminance level is not discovered, excessive power consumption will occur.

Therefore, there is a need for providing a light circuit which can solve the problem mentioned above.

### SUMMARY

A light circuit is provided in accordance with a preferred embodiment of the present invention. The light circuit includes a light unit, a control unit, a differentiation circuit and a switching circuit. The light unit includes a plurality of light branches connected in parallel. The light branches are controlled to light by the switching circuit that is switched on and off alternately under control of the control unit by use of PWM waves. The PWM waves are differentiated into differentiated waves by the differentiation circuit before being outputted to control the switching circuit.

Other advantages and novel features will be drawn from the following detailed description with reference to the attached drawings, in which:

### BRIEF DESCRIPTION OF THE DRAWINGS

FIG. 1 shows an exemplary application of a light circuit;

FIG. 2 shows a block diagram of the light circuit in accordance with a preferred embodiment of the present invention;

FIG. 3 shows a schematic connection between an ambient light switch and a lighting switch of the light circuit of FIG. 1;

FIG. 4 is a block diagram of a control unit of the light circuit of FIG. 1; and

FIG. 5 shows a segment of a schematic circuit diagram of the light circuit of FIG. 1.

### DETAILED DESCRIPTION OF THE EMBODIMENTS

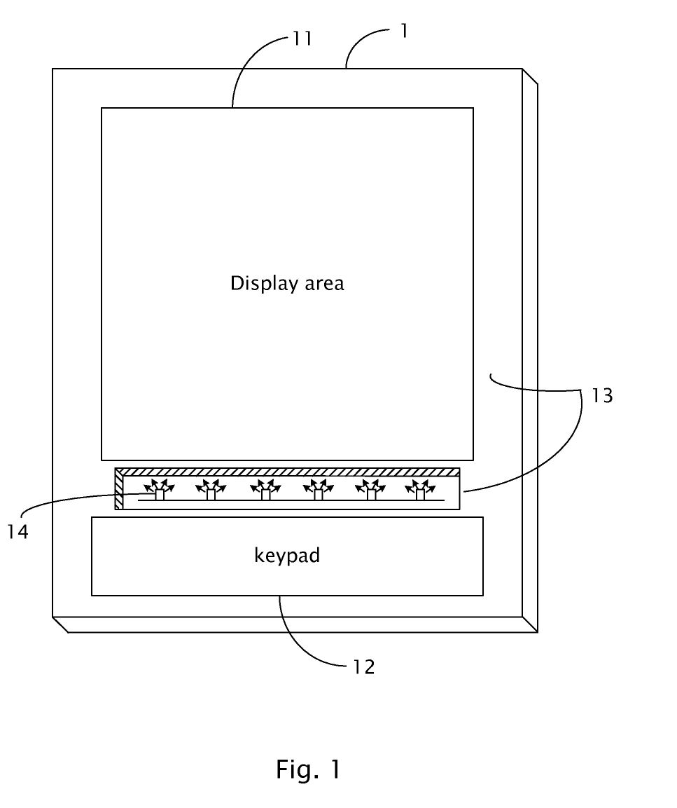

Referring to FIG. 1, an exemplary application of a light circuit to light an electronic book 1 that includes a display area 11 and a keypad 12 is depicted. A plurality of electroluminescent bodies 14 of the light circuit surrounds the display area 11 and lights the display area 11. Light from the electroluminescent bodies provides better viewing conditions when the electronic book 1 is in an environment with insufficient ambient light.

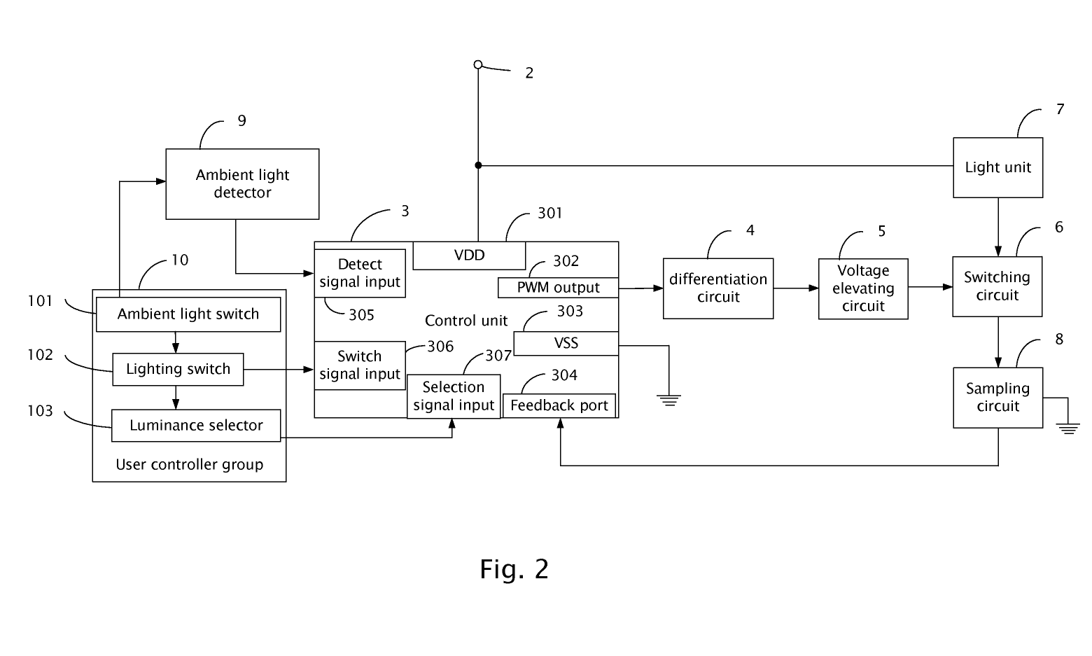

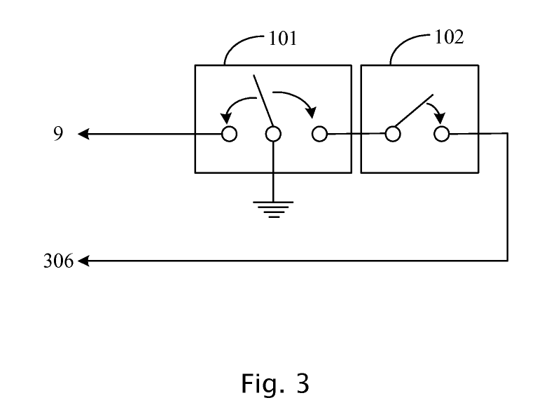

Referring to FIGS. 2 and 3, the light circuit includes a control unit 3 and a light unit 7 that employs the electroluminescent bodies 14 so as to light an electronic device such as the electronic book 1 mentioned above. The control unit 3 and the light unit 7 receive power from a direct current (DC) power source 2. The control unit 3 includes a VDD pin 301 connected to the DC power source 2, a PWM (pulse width modulation) output port 302 to output PWM waves that controls a luminance of the electroluminescent bodies 14 of the light unit 7, a VSS pin 303 connected to ground, and a feedback port 304 for receiving feedback information of a current luminance of the electroluminescent bodies 14 from a sampling circuit 8. The control unit 3 further includes a detect signal input port 305, a switch signal input port 306, and a selection signal input port 307. The detect signal input port 305 is provided for receiving light detect signals from an ambient light detector 9 that is used to detect ambient luminance of the environment where the electronic device is located. The switch signal input port 306 is provided for receiving switch signals from a lighting switch 102 that is provided to enable/disable the light circuit. The selection signal input port 307 is provided for receiving selection signals from a luminance selector 103 that is provided to manually select a luminance value of the light circuit.

The lighting switch 102 and the luminance selector 103 are included in a user control group 10 together with an ambient light switch 101 that is provided to enable/disable the ambient light detector 9. The user control group 10 is configured at a predetermined location on the electronic device, such as at the keypad 12 of the electronic book 1 illustrated relatively with FIG. 1. In FIG. 2 the ambient light switch 101 determines an operation of the lighting switch 102. The relationship between the ambient light switch 101 and the lighting switch 102 is illustrated relatively with FIG. 3. In FIG. 3 the ambient light switch 101 is a changeover switch that either connects the ambient light detector 9 or the lighting switch 102 to ground according to operational inputs. The lighting switch 102 is a simple on/off switch that is enabled when grounded by the ambient light switch 101. In alternative embodiments, the ambient light switch 101 and the lighting switch 102 can be configured so that an operation of the ambient light switch 101 is determined by the lighting switch 102, in that situation the lighting switch 102 can be a changeover switch and the ambient light switch 101 be a simple on/off switch.

The lighting switch 102 restricts an operation of the luminance selector 103. That is, the luminance selector 103 is enabled only after the light circuit is lit on by the lighting switch 102.

The control unit 3 outputs the PWM waves to a differentiation circuit 4. The differentiation circuit 4 differentiates the PWM waves to produce differentiated waves. The differentiated waves are input to a voltage elevating circuit 5 to elevate a voltage of the differentiated waves before being used to control a switching circuit 6. The switching circuit 6 switches on according to the differentiated waves and forms a conduction path from the light unit 7 to ground via the sampling circuit 8, thus to turn on the electroluminescent bodies 14 of the light unit 7.

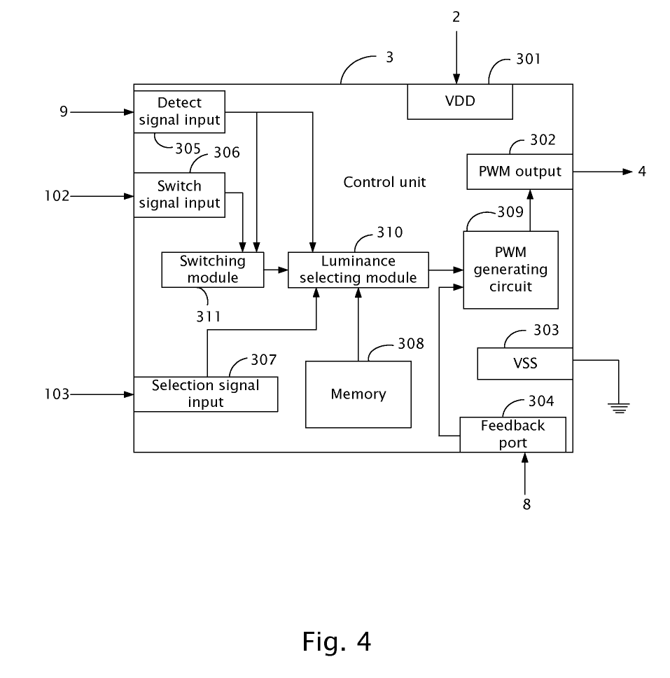

Referring to FIG. 4, the control unit 3 further includes a memory 308, a switching module 311, a luminance selecting module 310 and a PWM generating circuit 309. The switching module 311 receives the light detect signals via the detect signal input port 305 or receives the switch signals via the switch signal input port 306, and enables the luminance selecting module 310 accordingly. The luminance selecting module 310 receives ambient luminance values from the light detect signals or receives selected luminance values of the light circuit from the selection signals, and controls the PWM generating circuit 309 to generate PWM waves with suitable duty cycles. Specifically, the memory 308 stores a plurality of preset luminance values and a plurality of preset ambient luminance intervals, each preset ambient luminance interval corresponding to a preset luminance values. When an ambient luminance value is received, the luminance selecting module 310 first determines a particular preset ambient luminance interval that the received ambient luminance value falls in and then determines a particular preset luminance value according to the particular preset ambient luminance interval. When a selected luminance value is received, the luminance selecting module 310 directly determines a particular preset luminance value. The particular preset luminance value is then transmitted to the PWM generating circuit 309. Generally, one of the preset luminance values is specified as a default luminance value. The luminance selecting module 310 selects the default luminance value if no selected luminance value and ambient luminance value is received after being enabled by the switching module 311 for a preset time.

The PWM generating circuit 309 receives feedback information on current luminance of the electroluminescent bodies 14 from the feedback port 304, compares the feedback information with the preset luminance value that the luminance selecting module 310 transmits, and controls duty cycles of the PWM waves it produces according to the comparison result. The PWM waves are then used to switch on and off the switching circuit 6 alternately and controls the electroluminescent bodies 1 4 to light in accordance with the preset luminance value.

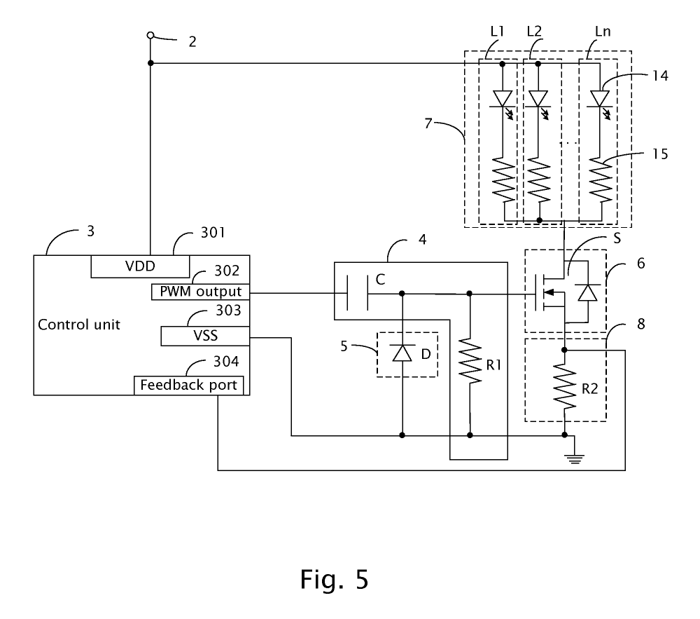

Referring to FIG. 5, the light unit 7 includes a plurality of light branches L1, L2 . . . and Ln that are connected in parallel between the DC power source 2 and the switching circuit 6. Each light branch Ln includes an electroluminescent body 14 and a resistance component 15 in series with the electroluminescent body 14. In FIG. 5 the electroluminescent bodies 14 are light emitting diodes (LEDs) and the resistance components 15 are employed to achieve resistance balances between the light branches L1, L2 . . . and Ln. The switching circuit 6 includes a MOSFET (Metal Oxide Semiconductor Field Effect Transistor) transistor S. The MOSFET transistor S includes a gate, a source and a drain. The gate is controlled by the differentiated PWM waves from the voltage elevating circuit 5, the drain is connected with the light unit 7, and the source is connected with the sampling circuit 8. The sampling circuit 8 is a resistor R2 connected between the source of the switching circuit 6 and ground. The feedback information is outputted to the feedback port 304 of the control unit 3 at the connection between the resistor R2 and the switching circuit 6. The differentiation circuit 4 is a RC (resistor/capacitor) differentiation circuit and includes a resistor R1 and a capacitor C. The voltage elevating circuit 5 is a diode D inversely connected between the gate of the switching circuit 6 and ground.

The PWM waves from the PWM output port 304 of the control unit 3 are differentiated by the differentiation circuit 4 into differentiated waves. The differentiated waves are elevated in voltage by the voltage elevating circuit 5 before being used to control the operation of the switching circuit 6. When the control unit 3 fails and outputs 100% duty cycle PWM waves uninterruptedly, the electroluminescent bodies 14 will turn off quickly and thus alert a failure.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A light circuit comprising a light unit, a control unit, a differentiation circuit and a switching circuit, wherein:
the light unit comprises a plurality of light branches connected in parallel, each of the light branches contains at least one light source, the light source is actuated by the switching circuit that is enabled and disabled by PWM waves from the control unit, the PWM waves are differentiated into differentiated waves by the differentiation circuit before outputted to the switching circuit.

2. The light circuit as claimed in claim 1, further comprising a voltage elevating circuit for elevating a voltage of the differentiated waves.

3. The light circuit as claimed in claim 2, wherein the voltage elevating circuit comprises a diode, the cathode of the diode is connected between the differentiation circuit and the switching circuit and the anode of the diode is grounded.

4. The light circuit as claimed in claim 1, further comprising a sampling circuit for obtaining feedback information on current luminance of the light unit to the control unit, the feedback information being used to control the generation of the PWM waves in the control unit.

5. The light circuit as claimed in claim 1, wherein the light unit, the switching unit and the sampling circuit are connected in series between a direct current (DC) power source and ground.

6. The light circuit as claimed in claim 1, wherein each light branch further comprises a resistance component, the resistance component is used for resistance balance between the light branches.

7. The light circuit as claimed in claim 1, wherein the switching circuit is a MOSFET ((Metal Oxide Semiconductor Field Effect Transistor) transistor.

8. The light circuit as claimed in claim 1, wherein the differentiation circuit is a RC (resistor-capacitor) differentiation circuit.

9. The light circuit as claimed in claim 1, wherein the light source is a light emitting diode (LED).
